(19) United States
(12) Patent Application Publication
(10) Pub. No.: US 2018/0189270 A1
(43) Pub. Date: Jul. 5, 2018

(54) Language Data Processing System Using Auto Created Dictionaries

(71) Applicant: Bank of America Corporation, Charlotte, NC (US)

(72) Inventors: Pinak Chakraborty, Telangana (IN); Gaurav Bansal, Madhya Pradesh (IN)

(21) Appl. No.: 15/396,890

(22) Filed: Jan. 3, 2017

(51) Int. Cl. G06F 17/27; G06F 17/24

(52) U.S. Cl. CPC G06F 17/2785; G06F 17/24; G06F 17/277; G06F 17/2735; G06F 17/274

(57) ABSTRACT

Some aspects disclosed herein are directed to, for example, a system and method of receiving, by a computing device, a transcript comprising a plurality of words. The computing device may generate a modified transcript by removing one or more stop words or one or more commonly occurring words from the plurality of words in the transcript. The computing device may also determine, based on one or more words in the modified transcript, a topic for the transcript. Based on the topic for the transcript, a polarity for the transcript may be determined. Based on the polarity for the transcript, a training program to recommend may be determined.

### TECHNICAL FIELD

One or more aspects of the disclosure generally relate to computing devices, computing systems, and computer software. In particular, one or more aspects of the disclosure generally relate to computing devices, computing systems, and computer software that may be used for processing language data using automatically created dictionaries.

### BACKGROUND

Various methods of processing speech signals are known. For example, natural language processing may be used to determine the meaning of a word, phrase, or sentence in a file, document, and the like. Call center transcripts with interactions between agents and customers may be generated. Aspects described herein may be used to perform natural language processing of call center transcripts.

### SUMMARY

The following presents a simplified summary in order to provide a basic understanding of some aspects of the disclosure. The summary is not an extensive overview of the disclosure. It is neither intended to identify key or critical elements of the disclosure nor to delineate the scope of the disclosure. The following summary merely presents some concepts of the disclosure in a simplified form as a prelude to the description below.

Aspects described herein are directed to, for example, a system and method comprising receiving, by a computing device, a transcript comprising a plurality of words. The computing device may generate a modified transcript by removing one or more stop words or one or more commonly occurring words from the plurality of words in the transcript. The computing device may also determine, based on one or more words in the modified transcript, a topic for the transcript. Based on the topic for the transcript, a polarity for the transcript may be determined. Based on the polarity for the transcript, a training program to recommend may be determined.

In some aspects, determining the topic for the transcript may comprise determining the topic for the transcript by identifying one or more nouns or n-grams in the modified transcript. The transcript may comprise header data, and determining the topic for the transcript may comprise determining the topic for the transcript based on one or more words in the header data.

In some aspects, determining the polarity for the transcript may comprise determining a distance between a word vector of the modified transcript and a historical polarity of one or more words in the modified transcript. The distance may be a cosine distance. The method may further comprise determining the historical polarity of a word in the modified transcript based on a number of occurrences of the word and a total number of instances of words in historical transcript data.

In some aspects, determining the training program to recommend may further be based on a duration of the training. The method may also comprise generating, for display on a display device, a display indicating the training program.

### BRIEF DESCRIPTION OF THE DRAWINGS

The present disclosure is illustrated by way of example and not limited in the accompanying figures in which like reference numerals indicate similar elements and in which:

FIG. 1 illustrates an example operating environment in which various aspects of the disclosure may be implemented.

FIG. 2 illustrates another example operating environment in which various aspects of the disclosure may be implemented.

FIG. 3A illustrates an example method for processing language data using automatically created dictionaries in which various aspects of the disclosure may be implemented.

FIG. 3B illustrates at least a portion of an example method for processing language data using automatically created dictionaries in which various aspects of the disclosure may be implemented.

FIG. 3C illustrates at least a portion of an example method for processing language data using automatically created dictionaries in which various aspects of the disclosure may be implemented.

FIG. 4 illustrates an example feedback table for processing language data using automatically created dictionaries in which various aspects of the disclosure may be implemented.

### DETAILED DESCRIPTION

In the following description of various illustrative embodiments, reference is made to the accompanying drawings, which form a part hereof, and in which is shown, by way of illustration, various embodiments in which the claimed subject matter may be practiced. It is to be understood that other embodiments may be utilized, and that structural and functional modifications may be made, without departing from the scope of the present claimed subject matter.

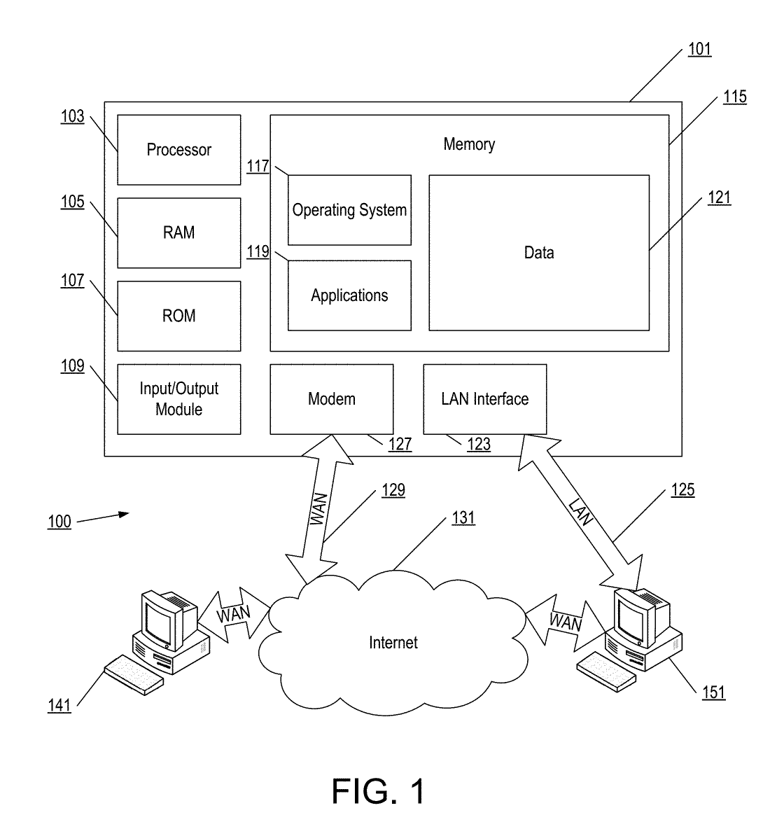

FIG. 1 illustrates an example block diagram of a computing device 101 (e.g., a computer server, desktop computer, laptop computer, tablet computer, other mobile devices, and the like) in an example computing environment 100 that may be used according to one or more illustrative embodiments of the disclosure. The computing device 101 may have a processor 103 for controlling overall operation of the server and its associated components, including for example random access memory (RAM) 105, read-only memory (ROM) 107, input/output (I/O) module 109, and memory 115.

I/O module 109 may include, e.g., a microphone, mouse, keypad, touch screen, scanner, optical reader, and/or stylus (or other input device(s)) through which a user of computing device 101 may provide input, and may also include one or more of a speaker for providing audio output and a video display device for providing textual, audiovisual, and/or graphical output. Software may be stored within memory 115 and/or other storage to provide instructions to processor 103 for enabling computing device 101 to perform various functions. For example, memory 115 may store software used by the computing device 101, such as an operating system 117, application programs 119, and an associated database 121. Additionally or alternatively, some or all of the computer executable instructions for computing device 101 may be embodied in hardware or firmware (not shown).

The computing device 101 may operate in a networked environment supporting connections to one or more remote computers, such as terminals 141 and 151. The terminals 141 and 151 may be personal computers or servers that include any or all of the elements described above with respect to the computing device 101. The network connections depicted in FIG. 1 include a local area network (LAN) 125 and a wide area network (WAN) 129, but may also include other networks. When used in a LAN networking environment, the computing device 101 may be connected to the LAN 125 through a network interface or adapter 123. When used in a WAN networking environment, the computing device 101 may include a modem 127 or other network interface for establishing communications over the WAN 129, such as the Internet 131. It will be appreciated that the network connections shown are illustrative and other means of establishing a communications link between the computers may be used. The existence of any of various well-known protocols such as TCP/IP, Ethernet, FTP, HTTP, HTTPS, and the like is presumed. Computing device 101 and/or terminals 141 or 151 may also be mobile terminals (e.g., mobile phones, smartphones, PDAs, notebooks, tablets, and the like) including various other components, such as a battery, speaker, and antennas (not shown).

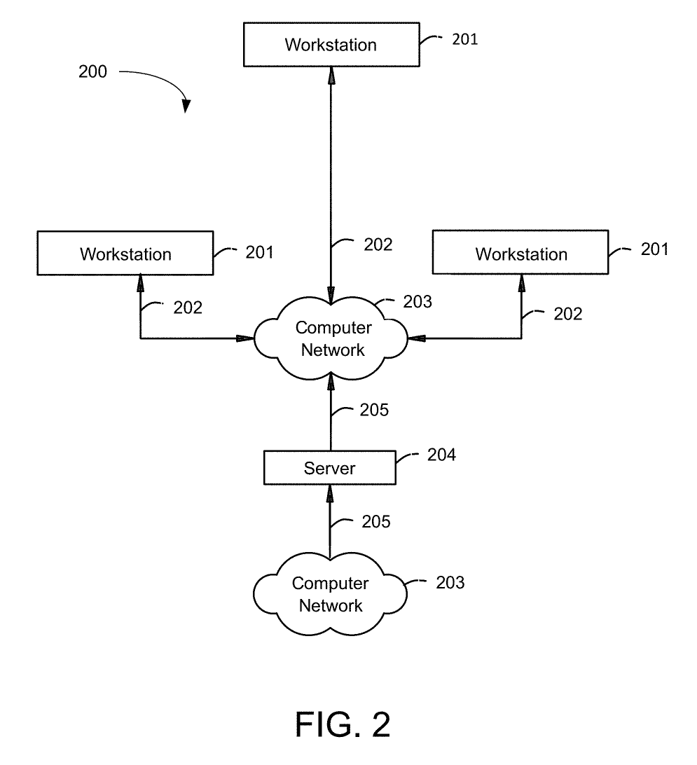

FIG. 2 illustrates another example operating environment in which various aspects of the disclosure may be implemented. An illustrative system 200 for implementing methods according to the present disclosure is shown. As illustrated, system 200 may include one or more workstations 201. The workstations 201 may be used by, for example, agents or other employees of an institution (e.g., a financial institution) and/or customers of the institution. Workstations 201 may be local or remote, and are connected by one or more communications links 202 to computer network 203 that is linked via communications links 205 to server 204. In system 200, server 204 may be any suitable server, processor, computer, or data processing device, or combination of the same.

Computer network 203 may be any suitable computer network including the Internet, an intranet, a wide-area network (WAN), a local-area network (LAN), a wireless network, a digital subscriber line (DSL) network, a frame relay network, an asynchronous transfer mode (ATM) network, a virtual private network (VPN), or any combination of any of the same. Communications links 202 and 205 may be any communications links suitable for communicating between workstations 201 and server 204, such as network links, dial-up links, wireless links, hard-wired links, and the like.

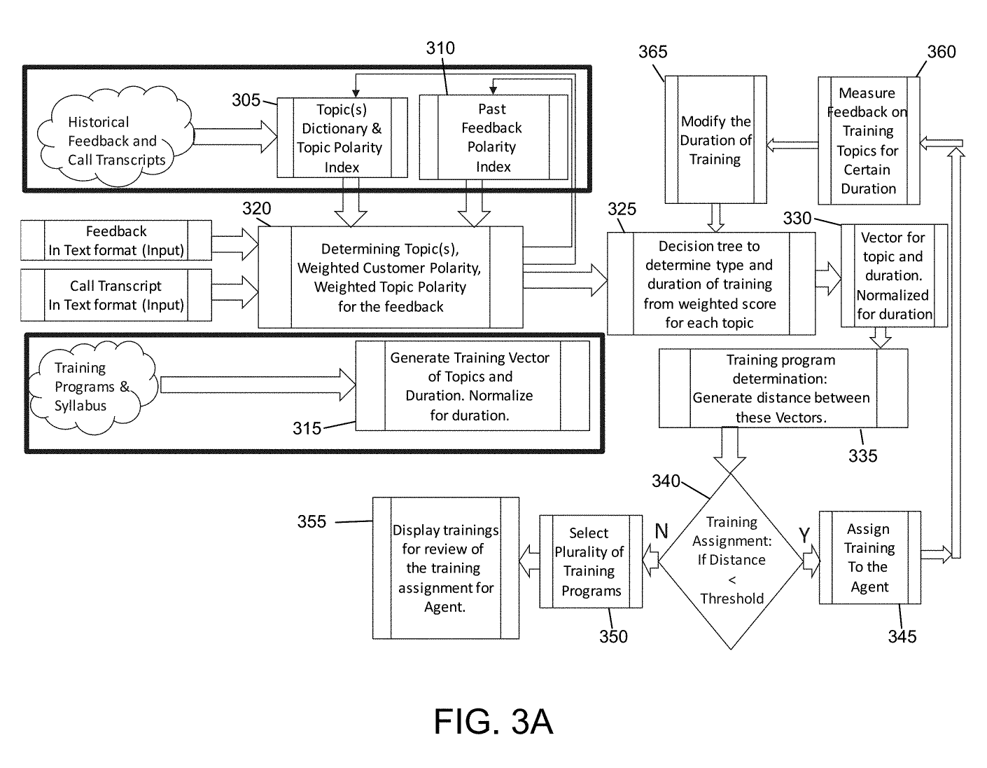

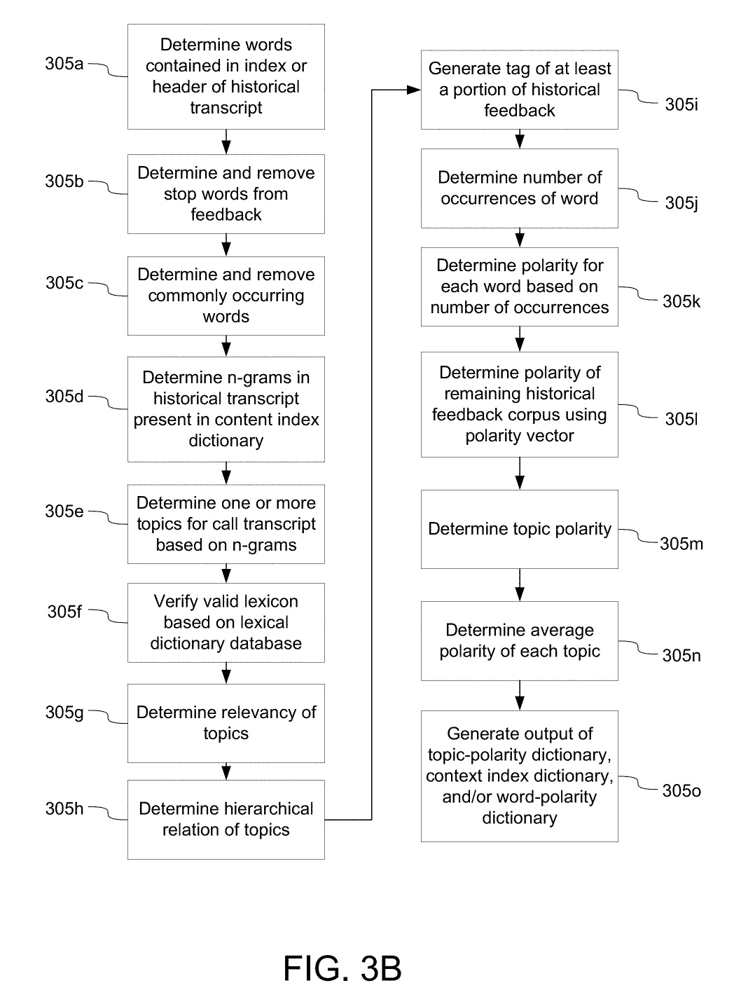

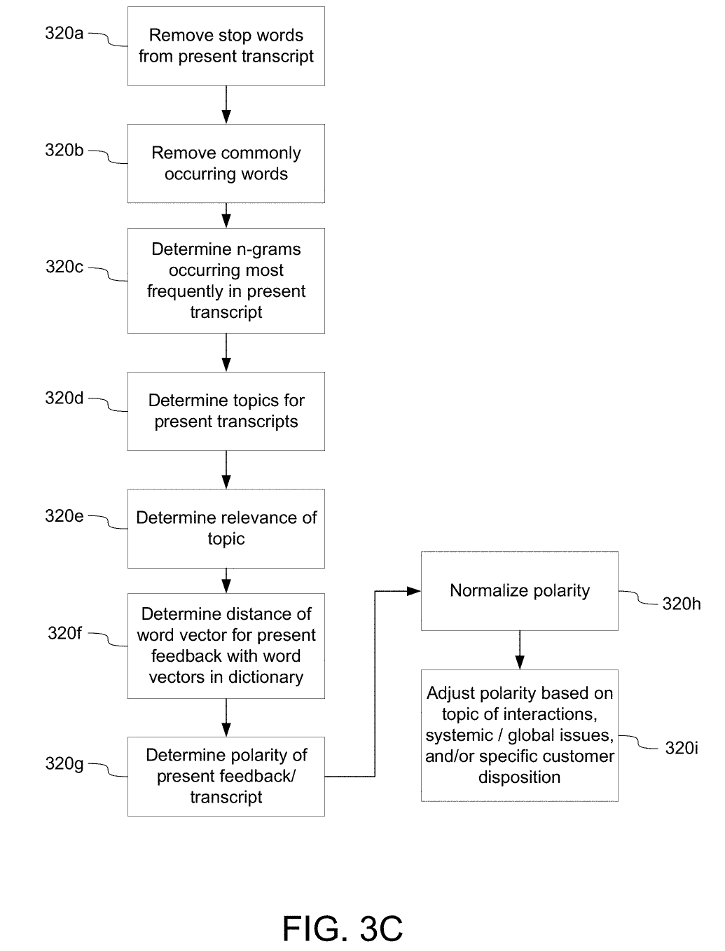

FIG. 3A illustrates an example method for processing language data using automatically created dictionaries in which various aspects of the disclosure may be implemented. One or more of the steps illustrated in FIG. 3A may be performed by a computing device as described herein.

In step 305, a computing device may generate a topic dictionary. For example, a natural language processing (NLP) engine may be used to create a topic dictionary and overall topic polarity from the historical data of call transcripts and associated customer feedback. It may take available historical data on customer feedback and the associated call transcript and determine, for example, noun phrases contained in it. The computing device may determine that one or more noun phrases that occur most rarely in the corpus of historical data, but are present in a dictionary database (e.g., a lexical dictionary database, which may include words in English), is a topic. For each topic, the system may determine the overall polarity from feedback on that topic. Topic polarity may be automatically updated in a frequency. Additional details for generating the topic dictionary will now be provided.

The NLP engine may receive various inputs, including, for example, historical customer feedback (HCF), historical customer call transcript (HCT) related to the feedback, and/or textual description (TD) on products and/or features supported by an institution. After receiving the data inputs, the NLP engine may perform one or more processes to transform the data. FIG. 3B illustrates at least a portion of an example method for processing language data using automatically created dictionaries in which various aspects of the disclosure may be implemented.

The system may determine one or more topics. In step 305a, from the textual description, the computing device may determine one or more words contained in the index and/or in the header of the historical customer call transcript. The computing device may build a content index dictionary (CID). In step 305b, the computing device may determine one or more stop words and remove one or more of the stop words from the historical customer feedback. In step 305c, the computing device may determine one or more of the most commonly occurring words in the corpus of historical data and remove one or more of the most commonly occurring words. After removing one or more words according to the above process, in step 305d, the computing device may determine n-grams that frequently occur in a historical customer call transcript and is present in the content index dictionary. In step 305e, the computing device may determine one or more topics for the historical customer call transcript based on the n-grams. For example, the n-grams may comprise the topic of the historical customer call transcript. In some aspects, the computing device, in step 305f, may verify that these are valid lexicon from a lexical dictionary database. In step 305g, the computing device may also determine a relevancy of the topic based on the frequency of the n-gram in the historical customer call transcript. In step 305h, the computing device may use the co-occurrence of words in an n-gram to determine hierarchical relation of the topics. For example, under cards, there may be additional topics, such as credit cards and debit cards. Similarly, for credit cards, there may be additional sub topics of travel credit cards, cash reward credit cards, and the like.

The system may determine one or more topic polarities. The data may be trained for supervised learning. In step 305i, the computing device may generate a tag of a portion of the historical customer feedback, the tag indicating the polarity of the feedback or portion of the feedback. For example, the polarity tag may be on a scale of 1-5, with 1 being the most negative and 5 being the most positive. After the tagging, the historical customer feedback identified for training may have a polarity assigned.

The computing device may remove one or more (e.g., all) stop words from the customer feedback and build a word vector for the historical customer feedback with the remaining words. The computing device may generate a word-polarity vector by determining a relative weight of the words in the word vectors and their relation with polarity. The word-polarity vector may be stored in, for example, a word-polarity dictionary (WPD).

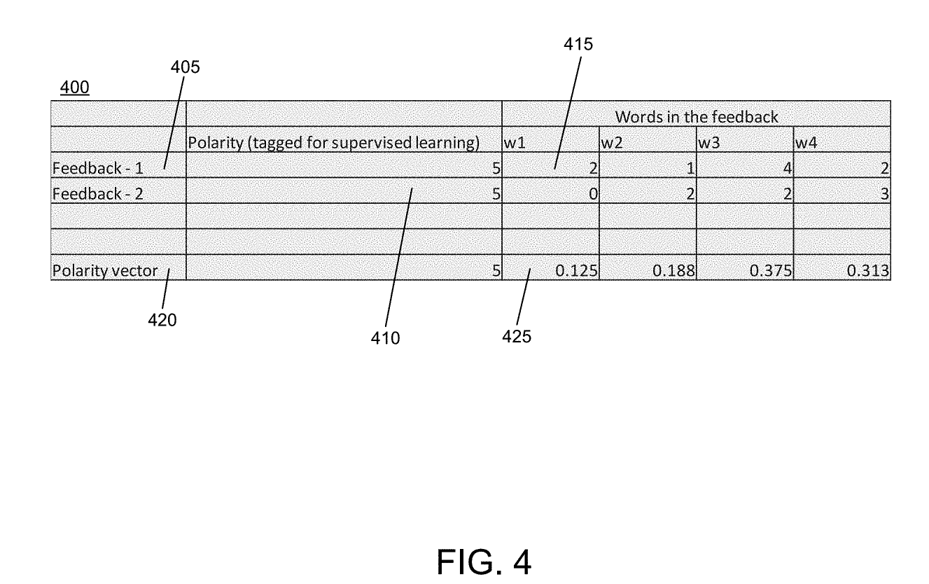

FIG. 4 illustrates an example feedback table 400 for processing language data using automatically created dictionaries in which various aspects of the disclosure may be implemented. An example of a polarity vector calculation is illustrated in FIG. 4. The table 400 may comprise one or more feedbacks 405 (e.g., Feedback-1, Feedback-2, and the like). As described above, each feedback 405 may be tagged with a polarity 410 (e.g., a polarity of 5), such as in step 305i illustrated in FIG. 3B. In step 305j, the computing device may determine the number of occurrences 415 of each word (e.g., w1, w2, and the like) in a word vector for the feedback, and store the number of occurrences in the table 400. In step 305k, the computing device may determine a polarity 420 (e.g., a polarity vector) for each word based on the number of occurrences of the word in the feedback and the total number of instances of words. For example, the table 400 includes 16 total instances of words for Feedback-1 and Feedback-2. Accordingly, the polarity 425 for word w1 may be 2/16 (e.g., 0.125). The polarity 420 for the remaining words, w2, w3, and w4, may similarly be calculated.

The polarity may be learned in a supervised manner. In step 305l, for the rest of the historical customer feedback, the computing device may use the relative weight of words to determine the polarity of the rest of the historical customer feedback corpus, such as by using the polarity vector calculated and stored in the word-polarity dictionary. For example, the cosine distance of the vectors in historical customer feedback may be matched against the polarity vector to determine the polarity of the feedback.

A topic dictionary may be created. In step 305m, based on the identified topic from a call transcript, and the polarity in the customer feedback, the computing device may determine the topic polarity. In step 305n, the computing device may also determine the average polarity for each topic. The computing device may store the topic and the average polarity of the topic in a topic-polarity dictionary (TPD). In some aspects, the topic polarity may be automatically updated in a frequency.

The computing device may output, in step 305o, the topic-polarity dictionary (TPD) (e.g., indicative of the polarity for each topic), the content index dictionary (CID), and the word-polarity dictionary (WPD) (e.g., indicative of the polarity for each word).

Returning to FIG. 3A, in step 310, the computing device may generate a user polarity table. For example, a database update program may be used to create a user feedback polarity table for users who have provided feedback in the past. For users who have provided feedback, the system may determine an overall polarity for feedback for a user and store it at an indexed table. User polarity may be automatically updated in a frequency. In step 310, the computing device may receive historical customer feedback data as input and may output a user and user average polarity table (UPD).

In step 315, the computing device may generate one or more training vectors. For example, a NLP engine may be used to create a vector representation of available training programs, which may also include training duration (e.g., normalized) as a dimension. The NLP engine may create the vector representation of the available training programs by removing stop words and matching n-grams in the content of the training programs with the content index dictionary. The training vectors may also include training duration (e.g., normalized) as a dimension. The computing device may store the training vectors in a database, such as a training vector database (TVD). In step 315, the computing device may receive textual description of training content with duration as input and may output a vector representation of the training content and duration as one of the dimensions.

In step 320, the computing device may determine a discussion topic and/or topic polarity. For example, an NLP engine may be used to identify one or more topic of discussion and one or more topic discussion polarity from a specific customer feedback and the call transcript associated with that feedback. The computing device may receive one or more of the following as inputs: present customer feedback (PCF), present customer call transcript (PCT) related to feedback, topic-polarity dictionary (TPD), user and user average polarity table (UPD), content index dictionary (CID), and/or word-polarity dictionary (WPD). The computing device may process one or more of the inputs by transforming the data to generate one or more data outputs.

FIG. 3C illustrates at least a portion of an example method for processing language data using automatically created dictionaries in which various aspects of the disclosure may be implemented. In step 320a, the computing device may remove one or more (e.g., all) stop words from the present customer call transcript. In step 320b, the computing device may also remove commonly occurring words in the corpus. After removing one or more words, the computing device, in step 320c, may determine nouns or n-grams that occur most often in the present customer call transcript based on the content index dictionary (e.g., is present in the content index dictionary). In step 320d, the computing device may use these n-grams as the topic for the present customer call transcript. The computing device may additionally or alternatively determine the topic based on words or phrases in the index or header of the transcript.

In step 320e, the computing device may also determine the relevancy of the topic based on the frequency of the n-gram in the present customer call transcript. The co-occurrence of words in an n-gram may be used to determine a hierarchical relation of the topics.

The computing device may determine the topic polarity. For example, the computing device may remove stop words from the present customer feedback and build a word vector for the present customer feedback with the remaining words. In step 320f, the computing device may determine a distance (e.g., a cosine distance) between a word vector for the present customer feedback or transcript and word vectors in the word-polarity dictionary. In step 320g, the computing device may take the polarity of the closest (and/or within a threshold distance) word-polarity dictionary vector as the polarity of present customer feedback. In step 320h, the computing device may normalize the polarity with the topic and the user polarity from the topic-polarity dictionary and the user and user average polarity table to determine a weighted polarity.

In step 320i, the computing device may adjust based on the topic of interaction or feedback (e.g., some discussions may by nature be more likely associated with customer displeasure, not an issue associated with associate technique), systemic/global issues (e.g., a server outage or a global news event may result in a large number of customers having low sentiment), or specific customer disposition (e.g., a customer with many less than glowing feedbacks regardless of the associate may by nature be generally harder to please).

Returning to FIG. 3A, in step 325, the computing device may determine a duration of training. For example, a decision tree may be used to determine a duration of training from the weighted topic discussion polarity (based on polarity). In some aspects, the more negative the polarity, the longer the duration of training, and conversely, the more positive the polarity, the shorter the duration.

In step 330, the computing device may generate a topic vector. For example, an NLP engine may be used to create a vector representation of the topic of discussion and training duration (e.g., normalized) as a dimension. Generating the topic vector may comprise two different steps, such as (1) identification of the training topics, and (2) identification of duration. Assume that after stop word removal, word/n-gram occurrences of two example topics are as follows:

| | discussion_topic-1 | discussion_topic-2 |
|---|---|---|
| credit_card | 2 | 0 |
| credit_line | 1 | 0 |
| card | 4 | 0 |
| travel | 3 | 3 |
| airmile | 1 | 0 |
| business | 0 | 0 |
| cash_reward | 0 | 0 |
| lowest_interest_rate | 0 | 0 |
| digital_wallet | 2 | 0 |
| loan | 0 | 2 |
| mortgage | 0 | 3 |
| refinance | 0 | 1 |
| home_equity | 0 | 1 |
| auto | 0 | 0 |

The computing device may take the weighted average of the word/n-gram occurrences according to, for example, the following algorithm:

$$Weighted average of a word or n \text{-} gram = \frac{occurrence of the word or n \text{-} gram , {w}_{i} or n \text{-} {gram}_{i}}{{Σ}_{j} occurrence of {w}_{i} or n \text{-} {gram}_{j}}$$

By taking the weighted average of the word/n-gram occurrences, the vectors for these two topics may be as follows:

| | discussion_topic-1 | discussion_topic-2 |
|---|---|---|
| credit_card | 0.154 | 0 |
| credit_line | 0.077 | 0 |
| card | 0.308 | 0 |
| travel | 0.231 | 0.273 |
| airmile | 0.077 | 0.091 |
| business | 0 | 0 |
| cash_reward | 0 | 0 |
| lowest_interest_rate | 0 | 0 |
| digital_wallet | 0.154 | 0 |
| loan | 0 | 0.182 |
| mortgage | 0 | 0.273 |
| refinance | 0 | 0.091 |
| home_equity | 0 | 0.091 |
| auto | 0 | 0 |

Vectors for these topics may then be an array of numbers as shown below:

$$Discussion\_topic \text{-} 1 = Array [ \begin{matrix}0.154 & 0.077 & 0.308 & 0.231 & 0.077 & 0 & 0 \\ 0 & 0.154 & 0 & 0 & 0 & 0 & 0\end{matrix} ]$$

$$Discussion\_topic \text{-} 2 = Array [ \begin{matrix}0 & 0 & 0 & 0.273 & 0.091 & 0 & 0 \\ 0 & 0 & 0.182 & 0.273 & 0.091 & 0.091 & 0\end{matrix} ]$$

From the present customer feedback (PCF), the polarity of the feedback may be determined on a scale of 1 to 5 using a Bayesian probability algorithm. The polarity determined from Bayesian algorithm may be normalized with a topic-polarity dictionary (TPD) and user average polarity table (UPD) to determine the weighted polarity of the feedback. The duration of the training may be determined from the weighted polarity of the feedback using a decision tree. This duration may then be normalized using the mean and standard deviation of the weighted word or n-gram occurrences in the topic vector determined in, for example, step (1) above.

In step 335, the computing device may determine one or more training programs. The computing device may determine the distance (e.g., cosine distance) between a training vector and a topic vector. A cosine distance between training vectors and topic vectors may be used to determine the recommended training. The cosine distance may be determined according to the following algorithm:

$$Cosine distance ( w 1 , w 2 ) = \frac{{Σ}_{i} w {1}_{i} * w {2}_{i}}{\sqrt{{Σ}_{i} w {1}_{i}^{2}} * \sqrt{{Σ}_{i} w {2}_{i}^{2}}}$$

Moreover, in FIG. 3A, step 315 may be used to create the training vector, as described in paragraph 32 above. Similar to topic vector creation described above, the training vector may also be determined from occurrences of words or n-grams present in the content of the training and training syllabus. It may also be an array of weighted average of the word or n-gram occurrences and with duration normalized as one of the dimensions.

In step 340, the computing device may determine whether the determined distance is less than a threshold. If so (step 340: Y), the computing device may assign the selected training to the agent (and/or generate a display indicating the selected training) in step 345. In some aspects, if a cosine distance between the closest training program and the topic of discussion is less than a threshold, the system may automatically assign this training program to the agent. Otherwise (step 340: N), the computing device may proceed to step 350.

In step 350, the computing device may select, for example, a plurality of training programs, such as a plurality of the closest training programs (e.g., the three closest training programs). In step 355, one or more of the plurality of training programs may be displayed (e.g., as a graphical user interface) on a display device of the agent or a supervisor of the agent. The training may additionally or alternatively be automatically identified using a predetermined mapping of topic and training. If a training is web-based, the training may be added to a training portal for the agent. If the training is instructor-based (e.g., live), the computing device may instruct the agent's electronic calendar to be blocked for the training, such as by sending a calendar invite.

The training duration for one or more agents may be automatically modified. In step 360, the training completion may be tracked. Once the training is completed, the next set of customer feedback for the same agent may be analyzed. For example, once the computing device detects that training has been completed by the agent, the system may monitor the additional feedback received for the agent for a particular duration of time (e.g., next 2-3 months) on one or more of the training topics.

In step 365, if the same topic, feedback, and/or polarity is identified again for the agent, the training might not have been effective. On the other hand, if the feedback and/or polarity has improved the second time around, the training may have been effective. Based on the subsequent feedback and/or polarity, the training duration for the agent may be modified. Additionally or alternatively, trainings on the same topic or different topics may be assigned to the agent based on the subsequent feedback and/or polarity.

Various technological advantages, including making computing devices more dynamic and efficient, result from performing one or more of the aspects described herein. For example, with the maturity of natural language processing and with statistical machine learning concepts applied to natural language processing, the computing devices herein are much more robust and effective for automatically learning to identify and assign training programs for agents. Aspects described herein may be used to efficiently identify topics of discussion. For example, the computing device may consider the feedback customers have provided immediately after an interaction with the agent to identify relevant topic of discussion and the associated feedback with the call transcript.

Aspects described herein may be used to quickly and accurately determine the polarity of specific feedback. As described above, the computing device may consider the overall polarity of feedback from a particular customer, as well as overall polarity on a topic from more than one customer (e.g., all customers) while calculating the polarity for specific feedback. This may be used to remove any bias view of a customer. Similarly, a particular topic, like a call for collection, may inherently carry negative feedback. Therefore, while calculating polarity of specific feedback, the weighted average of user bias as well as topic bias may be considered. The weights applied to feedback may be adjusted automatically as the model learns from the most current data.

Aspects described herein may be used to quickly and accurately determine training needs for agents. For example, the computing system may consider different (but similar) trainings that exist for a topic, as well as different training durations to cater to different training needs. Trainings may also be automatically assigned or displayed on a display device. Training documents, when expressed in vector forms of topic that they cover and training needs also expressed in vector of topics on which an agent is to be trained on, can be compared in a cosine distance function to determine one or more of the closest training programs available. If the cosine distance between these vectors is less than a threshold, the trainings could be automatically assigned. Otherwise, a plurality of the closest training programs may be displayed for the agent or for a supervisor to decide which one of these the agent is to attend.

Various aspects described herein may be embodied as a method, an apparatus, or as computer-executable instructions stored on one or more non-transitory and/or tangible computer-readable media. Accordingly, those aspects may take the form of an entirely hardware embodiment, an entirely software embodiment (which may or may not include firmware) stored on one or more non-transitory and/or tangible computer-readable media, or an embodiment combining software and hardware aspects. Any and/or all of the method steps described herein may be embodied in computer-executable instructions stored on a computer-readable medium, such as a non-transitory and/or tangible computer readable medium and/or a computer readable storage medium. In addition, various signals representing data or events as described herein may be transferred between a source and a destination in the form of light and/or electromagnetic waves traveling through signal-conducting media such as metal wires, optical fibers, and/or wireless transmission media (e.g., air and/or space).

Aspects of the disclosure have been described in terms of illustrative embodiments thereof. Numerous other embodiments, modifications, and variations within the scope and spirit of the appended claims will occur to persons of ordinary skill in the art from a review of this disclosure. For example, one of ordinary skill in the art will appreciate that the steps illustrated in the illustrative figures may be performed in other than the recited order, and that one or more steps illustrated may be optional in accordance with aspects of the disclosure.

1. A method comprising:
receiving, by a computing device, a plurality of historical transcripts;
removing one or more stop words or one or more commonly occurring words from the plurality of historical transcripts to generate a plurality of modified historical transcripts, wherein each modified historical transcript of the plurality of modified historical transcripts comprises a plurality of words;
creating a word vector for each historical transcript of the plurality of historical transcripts, wherein the word vector for each historical transcript comprises a plurality of weights respectively associated with the plurality of words in each modified historical transcript;
assigning a plurality of polarities respectively to the plurality of historical transcripts;
receiving, by the computing device, a first transcript comprising a plurality of words;
generating, by the computing device, a modified first transcript by removing one or more stop words or one or more commonly occurring words from the plurality of words in the first transcript;
after generating the modified first transcript, identifying one or more nouns or n-grams in the modified first transcript;
determining, by the computing device and based on the one or more nouns or n-grams in the modified first transcript, a topic for the first transcript;
determining a word vector for the first transcript, wherein the word vector for the first transcript comprises a plurality of weights respectively associated with a plurality of words in the modified first transcript;
determining, based on a distance between the word vector for the first transcript and the word vector for each historical transcript, a polarity for the first transcript;
determining, based on the polarity for the first transcript, a training program to recommend; and
transmitting, by the computing device and to a display device, a recommendation for the training program.

2. (canceled)

3. The method of claim 1, wherein the first transcript comprises header data, and wherein determining the topic for the first transcript comprises determining the topic for the first transcript based on one or more words in the header data.

4. The method of claim 1, wherein determining the polarity for the first transcript comprises determining the polarity for the first transcript to be a polarity associated with a historical transcript, of the plurality of historical transcripts, whose word vector is within a threshold distance to the word vector for the first transcript.

5. The method of claim 41, wherein the distance comprises a cosine distance.

6. The method of claim 41, further comprising:
determining a weight associated with a word of the plurality of words in each modified historical transcript based on a number of occurrences of the word and a total number of the plurality of words in each modified historical transcript.

7. The method of claim 1, wherein determining the training program to recommend is further based on a duration of the training.

8. (canceled)

9. An apparatus, comprising:
a processor; and
memory storing computer-executable instructions that, when executed by the processor, cause the apparatus to:
receive, by a computing device, a plurality of historical transcripts;
remove one or more stop words or one or more commonly occurring words from the plurality of historical transcripts to generate a plurality of modified historical transcripts, wherein each modified historical transcript of the plurality of modified historical transcripts comprises a plurality of words;
create a word vector for each historical transcript of the plurality of historical transcripts, wherein the word vector for each historical transcript comprises a plurality of weights respectively associated with the plurality of words in each modified historical transcript;
assign a plurality of polarities respectively to the plurality of historical transcripts;
receive a first transcript comprising a plurality of words;
generate a modified first transcript by removing one or more stop words or one or more commonly occurring words from the plurality of words in the first transcript;
after generating the modified first transcript, identify one or more nouns or n-grams in the modified first transcript;
determine, based on the one or more nouns or n-grams in the modified first transcript, a topic for the first transcript;
determine a word vector for the first transcript, wherein the word vector for the first transcript comprises a plurality of weights respectively associated with a plurality of words in the modified first transcript;
determine, based on a distance between the word vector for the first transcript and the word vector for each historical transcript, a polarity for the first transcript;
determine, based on the polarity for the first transcript, a training program to recommend; and
transmit, to a display device, a recommendation for the training program.

10. (canceled)

11. The apparatus of claim 9, wherein the first transcript comprises header data, and wherein determining the topic for the first transcript comprises determining the topic for the first transcript based on one or more words in the header data.

12. The apparatus of claim 9, wherein determining the polarity for the first transcript comprises determining the polarity for the first transcript to be a polarity associated with a historical transcript, of the plurality of historical transcripts, whose word vector is within a threshold distance to the word vector for the first transcript.

13. The apparatus of claim 9, wherein the distance comprises a cosine distance.

14. The apparatus of claim 9, wherein the memory stores additional computer-executable instructions that, when executed by the processor, cause the apparatus to:
determine a weight associated with a word of the plurality of words in each modified historical transcript based on a number of occurrences of the word and a total number of the plurality of words in each modified historical transcript.

15. The apparatus of claim 9, wherein determining the training program to recommend is further based on a duration of the training.

16. (canceled)

17. One or more non-transitory computer-readable medium having instructions stored thereon that, when executed by one or more computing devices, cause the one or more computing devices to:
receive, by a computing device, a plurality of historical transcripts;
remove one or more stop words or one or more commonly occurring words from the plurality of historical transcripts to generate a plurality of modified historical transcripts, wherein each modified historical transcript of the plurality of modified historical transcripts comprises a plurality of words;
create a word vector for each historical transcript of the plurality of historical transcripts, wherein the word vector for each historical transcript comprises a plurality of weights respectively associated with the plurality of words in each modified historical transcript;
assign a plurality of polarities respectively to the plurality of historical transcripts;
receive a first transcript comprising a plurality of words;
generate a modified first transcript by removing one or more stop words or one or more commonly occurring words from the plurality of words in the first transcript;
after generating the modified first transcript, identify one or more nouns or n-grams in the modified first transcript;
determine, based on the one or more nouns or n-grams in the modified first transcript, a topic for the first transcript;
determine a word vector for the first transcript, wherein the word vector for the first transcript comprises a plurality of weights respectively associated with a plurality of words in the modified first transcript;
determine, based on a distance between the word vector for the first transcript and the word vector for each historical transcript, a polarity for the first transcript;
determine, based on the polarity for the first transcript, a training program to recommend; and
transmit, to a display device, a recommendation for the training program.

18. (canceled)

19. The one or more non-transitory computer-readable medium of claim 17, wherein the first transcript comprises header data, and wherein determining the topic for the first transcript comprises determining the topic for the first transcript based on one or more words in the header data.

20. The one or more non-transitory computer-readable medium of claim 17, wherein determining the polarity for the first transcript comprises determining the polarity for the first transcript to be a polarity associated with a historical transcript, of the plurality of historical transcripts, whose word vector is within a threshold distance to the word vector for the first transcript.

21. The method of claim 1, further comprising:
adjusting the polarity for first the transcript based on one or more of a server outage, a global news event that results in a large number of customers having low sentiment, or a specific customer disposition.

22. The method of claim 1, further comprising:
verifying that the one or more nouns or n-grams in the modified first transcript are valid lexicon from a lexical dictionary database.

23. The method of claim 1, further comprising:
creating a vector representation of available training programs by removing stop words and matching n-grams in the available training programs with a content index dictionary.

24. The method of claim 1, further comprising:
inputting the word vector for the first transcript and the polarity for the first transcript into a word polarity dictionary for determining polarities for additional transcripts.

25. The method of claim 1, wherein determining the training program is further based on a distance between the word vector for the first transcript and a word vector of a plurality of word vectors respectively associated with a plurality of training programs.
